(19) United States
(12) Patent Application Publication
(10) Pub. No.: US 2012/0027217 A1
(43) Pub. Date: Feb. 2, 2012

(54) APPARATUS AND METHOD FOR MERGING ACOUSTIC OBJECT INFORMATION

(75) Inventors: Hae-Jo JUN, Kimpo-si (KR); Jae-Kwan SON, Seongnam-si (KR); Sang-Gon AHN, Seoul (KR); Sung-Hwan LEE, Seoul (KR); Tae-Hyun CHO, Incheon-si (KR); Hyun-Duk CHOI, Seoul (KR)

(73) Assignee: PANTECH CO., LTD., Seoul (KR)

(21) Appl. No.: 13/164,429

(22) Filed: Jun. 20, 2011

(30) Foreign Application Priority Data
Jul. 28, 2010 (KR) 10-2010-0073054

(51) Int. Cl. H04R 29/00

(52) U.S. Cl. 381/58

(57) ABSTRACT

An apparatus and method for merging acoustic object information to provide an Augmented Reality (AR) service in which real images are merged with sounds. The acoustic object information merging apparatus includes an acoustic objectization unit, an acoustic object information creator and a merging unit. The method classifies sounds received in a microphone array to identify an object corresponding to the received sound. If there is a failure to identify an object for each sound, then a band-pass filter is applied to secondarily classify the received sounds. Acoustic object information is created and merged with a captured image or recorded sound. The acoustic object information may include additional information about the object identified as corresponding to the received sound.

### CROSS-REFERENCE TO RELATED APPLICATION

This application claims priority to and the benefit of Korean Patent Application No. 10-2010-0073054, filed on Jul. 28, 2010, which is incorporated by reference for all purposes as if fully set forth herein.

### BACKGROUND

1. Field

The following description relates to Augmented Reality (“AR”), and more particularly, to an apparatus and method for merging acoustic object information to provide an Augmented Reality (“AR”) service in which images are merged with sounds.

2. Discussion of the Background

Augmented reality (“AR”) is a kind of virtual reality (“VR”) that provides images in which a real world viewed by a user's eyes is merged with a virtual world providing additional information. AR is similar to existing VR. VR provides users with only virtual spaces and objects, whereas AR synthesizes virtual objects based on a real world to provide additional information that cannot be easily objected in the real world. Unlike VR based on a completely virtual world, AR combines virtual objects with a real environment to offer users a more realistic feel. AR has been studied in U.S. and Japan since the latter half of the 1990's. With improvements in the computing capability of mobile devices, such as a mobile phones and Personal Digital Assistants (“PDAs”), and the development of wireless network devices, various AR services are currently being provided.

For example, details and additional information associated with objects in a real environment captured by a camera of a mobile phone are virtually created and merged with the image of the object and then output to a display. However, conventional AR services are image-based services and there are limitations to providing various additional AR services.

### SUMMARY

Exemplary embodiments of the present invention provide an apparatus and method for providing an Augmented Reality (“AR”) service in which real images are merged with sounds.

Additional features of the invention will be set forth in the description which follows, and in part will be apparent from the description, or may be learned by practice of the invention.

An exemplary embodiment of the present invention discloses an acoustic object information merging apparatus including: an acoustic objectization unit to estimate a direction and a location of a received sound, to classify a sound pattern for the received sound based on the estimated direction and location of the received sound, and to identify an object for the received sound based on the sound pattern of the received sound; an acoustic object information creator to acquire additional information about the identified object for the received sound, and to create acoustic object information therefrom; and a merging unit to merge the acoustic object information with a real image or real sound.

An exemplary embodiment of the present invention discloses a method of creating acoustic object information associated with sounds and merging the acoustic object information with real images or sounds in a user terminal, the method includes: estimating a direction and a location of a sound received through a microphone array; classifying a sound pattern of the received sound based on the estimated direction and location of the received sound; identifying an object associated with a sound peak value of the sound pattern by referencing to a sound pattern database that stores sound peak values of a plurality of objects; acquiring additional information about the determined object to create acoustic object information for the received sound; and merging the acoustic object information with a real image or sound.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating an acoustic object information merging apparatus according to an exemplary embodiment.

FIG. 2 illustrates a microphone array of an acoustic object information merging apparatus according to an exemplary embodiment.

FIG. 3 is a flowchart depicting an illustrative acoustic object information merging method according to an exemplary embodiment.

FIG. 4 illustrates a merging of acoustic object information and a real image or sound according to an exemplary embodiment.

FIG. 5 illustrates a merging of acoustic object information and a real image or sound according to an exemplary embodiment.

FIG. 6 illustrates a merging of acoustic object information and a real image or sound according to an exemplary embodiment.

FIG. 7 illustrates a merging of acoustic object information and a real image or sound according to an exemplary embodiment.

### DETAILED DESCRIPTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity Like reference numerals in the drawings denote like elements.

It will be understood that, although the terms first, second, third etc. may be used herein to describe various elements or components these elements or components should not be limited by these terms. These terms are only used to distinguish one element or, component. Thus, a first element or component discussed below could be termed a second element or component without departing from the teachings of the present invention. It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

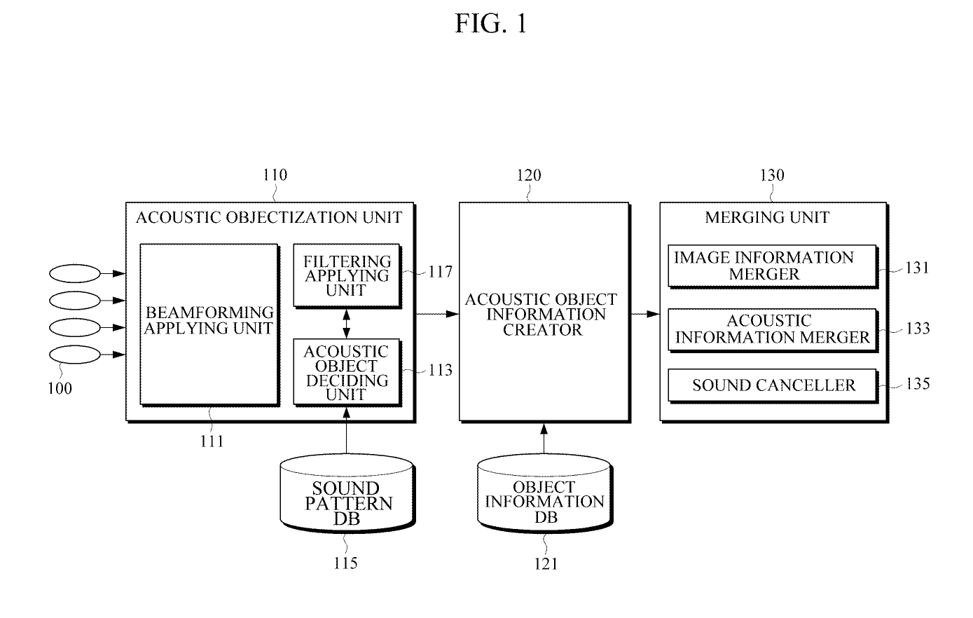

FIG. 1 is a diagram illustrating an acoustic object information merging apparatus according to an exemplary embodiment.

The acoustic object information merging apparatus (“AOIM apparatus”) includes an acoustic objectization unit 110, an acoustic object information creator 120 and a merging unit 130. The AOIM apparatus may be implemented in a terminal, for example, a cellular phone, PDA, desktop computer, tablet computer, laptop computer, etc. The acoustic objectization unit 110 estimates the directions and locations of a plurality of sounds that are received through a microphone array 100 to classify the sounds into a plurality of sound patterns and determines objects corresponding to the sounds according to the sound patterns. The acoustic objectization unit 110 determines objects corresponding to the received sounds according to sound patterns of the received sounds. In an exemplary embodiment, the sound pattern of the received sound may be sound peak values. The acoustic objectization unit 110 may include a beamforming applying unit 111 and an acoustic object deciding unit 113. The beamforming applying unit 111 classifies sounds received through a microphone array 100 into a plurality of sound tones using a beamforming technique.

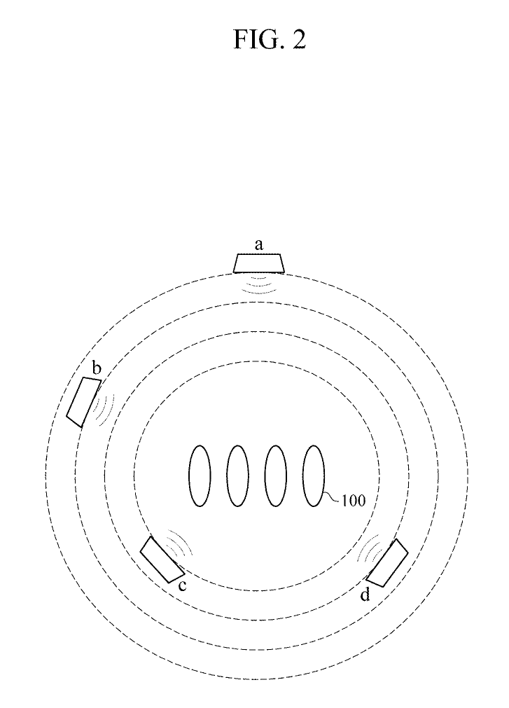

FIG. 2 illustrates a microphone array of an acoustic object information merging apparatus according to an exemplary embodiment. Generally, the microphone array 100 may be a combination of a plurality of microphones, and may receive sounds and additional characteristics regarding directivity, such as the directions or locations of the sounds.

The microphone array 100 receives sounds from different points a, b, c and d to determine the locations thereof, respectively. The sounds generated at points a, b, c and d forms a plurality of concentric circles centered on the microphone array. Accordingly, the microphone array 100 can obtain the angles and intensities of sounds received from the different points a, b, c and d. Sounds reach the microphone array 100 at different times because sounds are received from the points a, b, c and d at different times and accordingly the microphone array 100 can obtain the angles and intensities of the sounds generated at the points a, b, c and d.

Referring again to FIG. 1, when a plurality of sounds is received by the microphone array 100, the beamforming applying unit 111 classifies the received sounds using a beamforming technique. In an exemplary embodiment, the beamforming technique may be to adjust the directivity pattern of a microphone array to acquire only sounds in a desired direction from among the received sounds. The beamforming applying unit 111 acquires the directions and locations of a plurality of received sounds received by the microphone array 100, using the angles and intensities of the received sounds. The beamforming applying unit 111 classifies the sounds into a plurality of sound tones according to the directions and locations of the sounds.

The acoustic object deciding unit 113 acquires sound peak values of the sound tones and acquires sound characteristic information associated with the sound peak values from a sound pattern database (“DB”) 115. The sound pattern DB 115 stores sound peak values, which are sound characteristic information of various objects, such as a piano, cars, dogs and birds, etc. and information about the objects corresponding to the various sound peak values. However, aspects are not limited thereto such that the sound pattern DB 115 may be included in the AOIM apparatus and may be connected thereto in any suitable manner. The acoustic object deciding unit 113 acquires sound peak values of the individual sound tones classified by the beamforming applying unit 111 and objects corresponding to the sound peak values from the sound pattern DB 115. In an exemplary embodiment, the acoustic object deciding unit 113 extracts the sound peak values of the sound tones using Discrete Fourier Transform (“DFT”) or Fast Fourier Transform (“FFT”). After extracting the sound peak values of the sound tones, the acoustic object deciding unit 113 acquires objects corresponding to the sound peak values of the sound tones from the sound pattern DB 115. Thus, the acoustic object deciding unit may identify an object corresponding to each sound tone received by the microphone array.

When no object corresponding to at least one of the received sounds is acquired by the acoustic object deciding unit 113, the acoustic objectization unit 110 may determine an object corresponding to the sound by using a filtering applying unit 117. By way of example, the acoustic object deciding unit 113 may fail to identify objects corresponding to the received sound when two or more different sounds generated at the same location are simultaneously inputted to the microphone array 100. In this example, the beamforming applying unit 111 may not distinguish the two or more different sounds from each other because the beamforming applying unit 111 may classify sounds received from the same location into one sound tone. Thus, the acoustic object deciding unit 113 may fail to identify objects corresponding to sound peak values of the individual two or more different sounds from the sound pattern DB 115. The filtering applying unit 117 causes a received sound to be separated into separate sound tones using frequency and amplitude information from the received sound. The filtering applying unit 117 may classify the sound into a secondary sound tone by using a band-pass filter. The acoustic object deciding unit 113 acquires a sound peak value of the secondary sound tone classified by the filtering applying unit 117 and identifies an object corresponding to the sound peak value from the sound pattern DB 115. By acquiring a sound peak value of a secondary sound tone, an object corresponding to the sound tone can be distinctly recognized even if the received sound is mixed with noise.

After objects for the classified sound tones are identified by the acoustic object deciding unit 113, the acoustic object information creator 120 acquires details and additional information about the identified objects to create acoustic object information. The AOIM apparatus may further include an object information DB 121 which stores details and additional information about a plurality of objects. However, aspects need not be limited thereto such that, the object information DB 121 may be independent of the AOIM apparatus and may be connected thereto in any suitable manner. The acoustic object information creator 120 acquires details and additional information about the objects from the object information DB 121 to create acoustic object information.

By way of example, if a sound tone classified by the beamforming applying unit 111 is determined by the acoustic object deciding unit 113 to be a car sound, the acoustic object information creator 120 acquires information about the car such as car model information type and car-related additional information from the object information DB 121. The acoustic object information creator 120 creates acoustic object information based on the car model information and car-related additional information received. The acoustic object information may be in the form of characters, pictures or moving pictures.

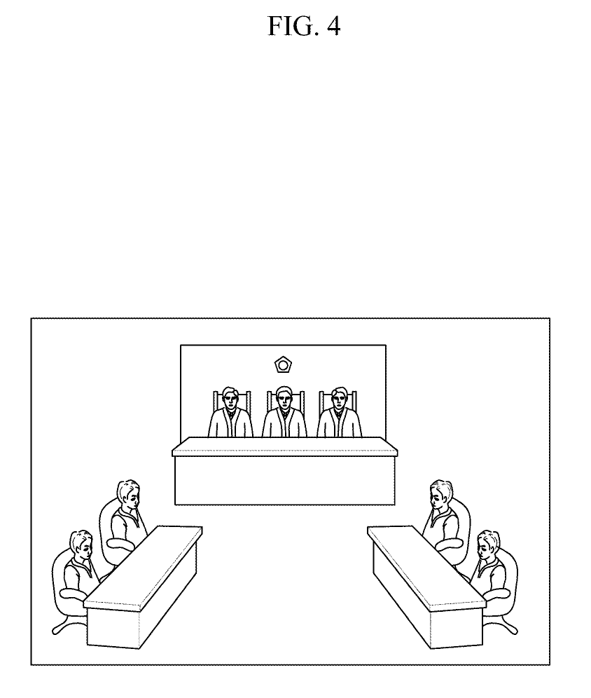

The merging unit 130 is used to merge each piece of acoustic object information created by the acoustic object information creator 120 with a real image or sound. The merging unit 130 includes an image information merger 131, an acoustic information merger 133 and a sound canceller 135. The image information merger 131 merges a real image captured by a camera of a user terminal with acoustic object information associated with the real image and output the resultant image onto a display of the user terminal. The merging unit 130 may merge the real image and the acoustic object information in response to a request from a user. By way of example, in an image captured during a meeting where multiple people are speaking in a meeting room. As shown in FIG. 4, the image information merger 131 merges the photographed real image with acoustic object information about the people who participated in the discussion. The image information merger 131 may output the resultant image onto a display of a user terminal connected to the AOIM apparatus. In an exemplary embodiment, the acoustic object information may be in the form of speech bubbles merged with the real image.

The acoustic information merger 133 outputs acoustic object information associated with a real sound or merges the acoustic object information with a real image. The real sound may be received by a microphone of a user terminal connected to the AOIM apparatus and the outputted acoustic object information may be outputted to the display of the user terminal. In an exemplary embodiment, the received sound may be stored in a user terminal of connected to the AOIM apparatus. The real image may be a captured image captured by the camera of a user terminal connected to the AOIM apparatus and the image resulting from the merging may be outputted to the display of the user terminal, in response to a request from the user. By way of example, if the sound of music on a street is received through the microphone of a user terminal connected to an exemplary AOIM apparatus, then the acoustic information merger 133 may output acoustic object information including information about the music to the display of the user terminal, or may merges the acoustic object information with a real image and then output the result of the merging to the display of the user terminal.

The sound canceller 135 cancels sounds not corresponding to a selected object from among objects in an image. The user may choose the selected object image from images outputted to the display of a user terminal connected to the AOIM apparatus. By way of example, a user may request, from an image of an orchestra performance captured by the camera of the user terminal, canceling of sounds corresponding to all musical instruments except the sounds of violins. If such a request is received, the sound canceller 135 then cancels sounds generated by the remaining musical instruments. Accordingly, the outputted acoustic object information the user may hear through the speaker of the user terminal may be the reproduction of the sounds of the violins.

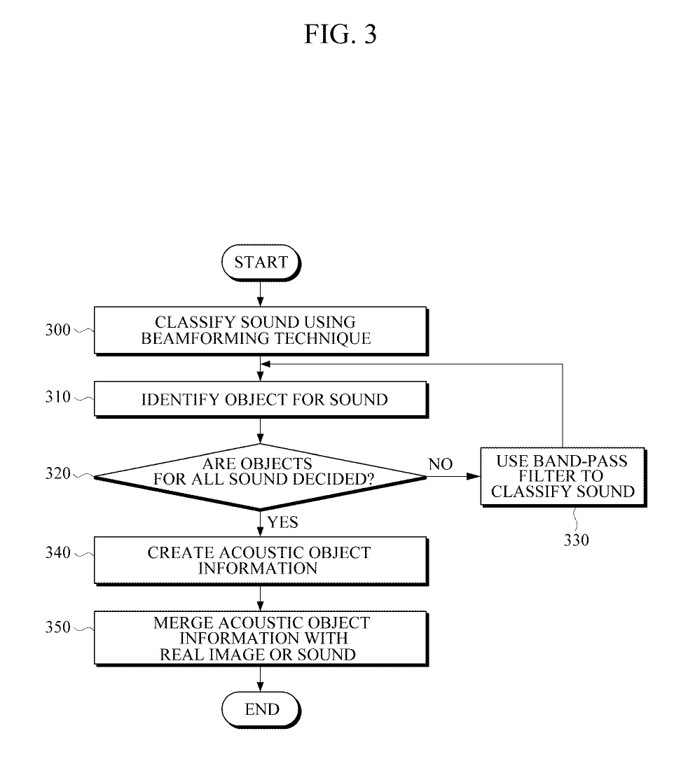

FIG. 3 is a flowchart depicting an illustrative acoustic object information merging method according to an exemplary embodiment.

Referring to FIG. 3, In operation 300, when sounds generated at a plurality of different locations are received through the microphone array, the AOIM apparatus uses a beamforming technique to estimate the directions and locations of the received sounds and classifies the sounds into a plurality of sound tones according to the directions and locations of the sounds. The beamforming technique may adjust the directivity pattern of the microphone array and acquire only desired sounds from among the received sounds. The AOIM apparatus uses the beamforming technique to determine the directions and locations of the sounds received by the microphone array, which may be, for example, based on the angles and intensities of the sounds, and thereby classifies the sounds into a plurality of sound tones. After classifying the sounds into the sound tones, the AOIM apparatus acquires a sound peak value for each sound tone. In an exemplary embodiment, the user terminal may extract a sound peak value for each sound tone using DFT or FFT.

In operation 310, the AOIM apparatus identifies an object that corresponds to each extracted sound peak value by referencing a sound pattern DB in which sound peak values of various objects are stored.

In operation 320, the AOIM apparatus determines whether objects have been identified for all the sound tones by referencing the sound pattern DB.

If no object has been identified for at least one received sound, in operation 330, the AOIM apparatus uses a band-pass filter to secondarily classify the sound whose associated object has not been determined. For example, when the AOIM apparatus receives two or more different sounds generated at or near the same location and time through the microphone array. In this case, the AOIM apparatus may fail to classify the different sounds into different sound tones using the beamforming technique. Accordingly, the AOIM apparatus may not have determined an object corresponding to the different sounds in operation 310. The AOIM apparatus classifies the sound whose associated object has not been identified into a sound tone based on the frequency and amplitude of the sound. Thereafter, the AOIM apparatus acquires sound peak values for each individual second sound tone classified by the band-pass filter. The AOIM apparatus then acquires objects having sound peak values corresponding to the sound peak values from the sound pattern DB. If at least one object is identified for a received sound, the method may proceed to operation 340.

In operation 340, after identifying objects for the individual sound tones, the user terminal further acquires details and additional information about the objects determined to correspond to the individual sound tones to create acoustic object information. For example, the AOIM apparatus acquires details and additional information about the identified objects determined to correspond to the individual sound tones by referencing an object information DB that stores such details and additional information about a plurality of objects. For example, where the object for a sound tone is determined to be a car, the AOIM apparatus acquires the car model information and car-related additional information and creates acoustic object information according to the acquired car model information and car-related additional information. The acoustic object information may be in the form of characters, icons, pictures or moving pictures.

In operation 350, based on a user request, the AOIM apparatus merges each piece of the acoustic object information with a real image or sound. For example, the AOIM apparatus determines whether there is a user's request for merging at least one piece of the acoustic object information with a real image or sound. If it is determined that there is a user's request for merging at least one piece of the acoustic object information with a real image, the AOIM apparatus merges a real image captured by a camera with acoustic object information associated with the real image. The real image may be an image captured by the camera of a user terminal connected to the AOIM apparatus and the image resulting from the merging may be outputted to a display of the user terminal. By way of example, in a photograph taken during a meeting where multiple people are speaking in a meeting room, the image information merger merges the captured real image with acoustic object information about the people who participated in the discussion. In an exemplary embodiment, the acoustic object information may be in the form of speech bubbles merged with the real image.

If it is determined that there is a user's request for merging at least one piece of the acoustic object information with a real sound, the user terminal may output acoustic object information associated with the real sound received. The sound may be received through a microphone of a user terminal connected to the AOIM apparatus and stored in the user terminal of the AOIM apparatus. The acoustic object information may be projected onto a display of the user terminal. By way of example, when the sound of music on a street is received by the microphone of a user terminal connected to an exemplary AOIM apparatus, the user terminal outputs acoustic object information including information about the music onto the display of the user terminal. However, aspects are not limited thereto such that the AOIM apparatus may merge acoustic object information associated with a real sound with a real image and outputs the result of the merging onto the display of a user terminal connected to the AOIM apparatus.

Further, the AOIM apparatus may cancel sounds corresponding to objects in an image on the display of a user terminal connected to the AOIM apparatus, according to a user request. By way of example, a user request for canceling sounds is received. The user request specifies violins, from an image of an orchestra performance captured by the camera of the user terminal, as objects whose sound is not to be canceled. Thus, the sound canceller 135 cancels sounds generated by the remaining musical instruments. Accordingly, the outputted acoustic object information the user may hears through the speaker of the user terminal is a reproduction of the sound of violins captured by the camera of the user terminal.

FIG. 4 illustrates a merging of acoustic object information and a real image or sound, sound according to an exemplary embodiment.

FIG. 4 corresponds to a case in which video for trial is captured by a camera of a user terminal connected to an exemplary AOIM apparatus. The AOIM apparatus objectizes participants participating in the trial based on the participants' voices. Then, the AOIM apparatus recognizes the objectized participants' voices using speech recognition to convert the voices into text, creates the text in a form of speech bubbles and then merges the speech bubbles with the trial video. Thereafter, if at least one participant is selected by a user from the merged trial video outputted onto the display of the user terminal, the AOIM apparatus may output speech bubbles created in association with the selected participant's voice onto the trial video and/or cancels voices of the remaining participants to output only the selected participant's voice through a speaker. Thus, the user can view or hear the speech of the participant through the display or speaker of the user terminal. However aspects are not limited thereto such that subtitles may be displayed on the display.

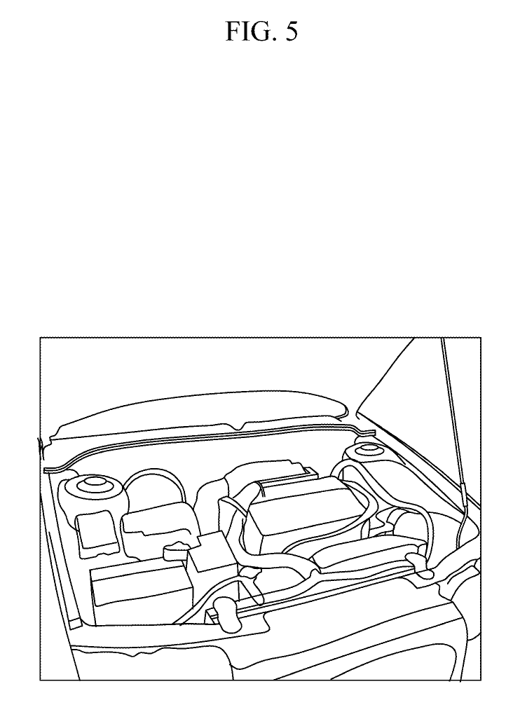

FIG. 5 illustrates a merging of acoustic object information and a real image or sound according to an exemplary embodiment.

In FIG. 5, a camera of a user terminal connected to an exemplary AMOI apparatus captures an image of an engine of a car. The AMOI apparatus objectizes sounds generated by the engine, which are received through a microphone array, merges acoustic object information (i.e., information about the engine parts) associated with the sounds with the real image photographed by the camera, and outputs acoustic object information corresponding to each part to a display of the user terminal. The AMOI apparatus may merge the real image showing the parts in the car with acoustic object information associated with the engine shown in the real image. The AMOI apparatus outputs the result of the merging and displays the acoustic object information near the location of the engine image on the display of the user terminal. Furthermore, the AMOI apparatus compares characteristic information about the received sounds of individual parts to characteristic information about sounds of parts stored in a database to determine whether the received sounds of the parts are in a normal state or in an abnormal state. Thus, the AMOI apparatus informs a user of the state of each part based on the result of the determination through a display on the user terminal connected to the AMOI apparatus. If it is determined that an engine sound from among the received sounds of the parts is in an abnormal state, the AMOI apparatus creates acoustic object information including a notice that the engine needs to be repaired. Then, the AMOI apparatus merges the real image with the acoustic object information including the notice such that the acoustic object information appears near the engine image on the real image, and outputs the resultant image onto the display of the user terminal. Accordingly, the user can easily and quickly recognize the fact that there is something wrong with the engine.

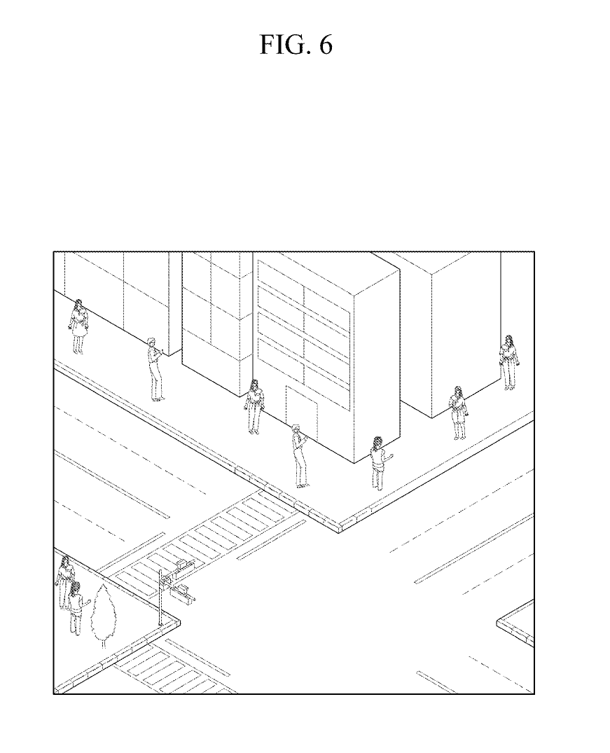

FIG. 6 illustrates a merging of acoustic object information and a real image or sound according to an exemplary embodiment.

In FIG. 6, a user photographs the street along which he or she is walking using a camera in a user terminal connected to an exemplary AMOI apparatus. If a plurality of pieces of music is received from different stores through a microphone array of the AMOI apparatus, the AMOI apparatus classifies the plurality of pieces of music using the beamforming technique to obtain sound peak values for the pieces of music and identifies objects, such as music titles, corresponding to the obtained sound peak values. The AMOI apparatus further acquires details, such as singers, recording labels, etc. about the objects, i.e. the objectized pieces of music, to create acoustic object information. Then, the AMOI apparatus merges the acoustic object information with the real image photographed by the camera and outputs the resultant image onto the display of the user terminal. Thus, the user terminal displays each piece of the acoustic object information near the corresponding store on the image displayed on the display. Accordingly, the user can use the AMOI apparatus to easily determine information about the music played by each store and may furthermore select a piece of music to download onto the user terminal.

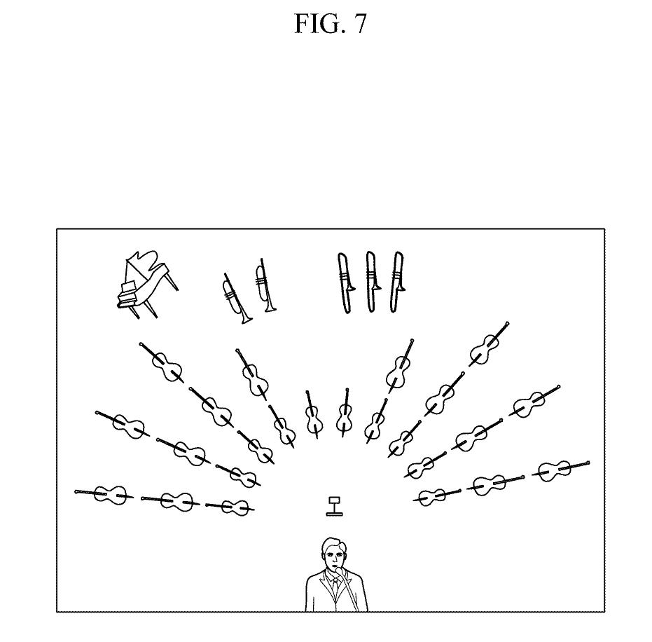

FIG. 7 illustrates a merging of acoustic object information and a real image or sound according to an exemplary embodiment.

In FIG. 7, a user photographs an orchestra performance through a camera of a user terminal connected to an exemplary AMOI apparatus. When sounds of various musical instruments are received through a microphone array, the AMOI apparatus classifies the sounds of the musical instruments using the beamforming technique to obtain sound peak values for the received sounds of the musical instruments and identifies objects (i.e. musical instruments) corresponding to each sound peak value. Thereafter, the AMOI apparatus further acquires details and additional information about the objects to create acoustic object information. The AMOI apparatus merges the acoustic object information with the real image captured by the camera and outputs the resultant image onto a display of the user terminal. Thus, the user may acquire information about each musical instrument from the image displayed on the display of the user terminal. Furthermore, when the user selects a particular musical instrument (e.g. violins) from the orchestra performance recorded by the camera of the user terminal the AMOI apparatus cancels the sounds of the remaining musical instruments. Accordingly, the user may listen to the reproduced sounds of the particular musical instrument.

The apparatus and method for merging acoustic object information disclosed herein provide an AR service in which real images are merged with sounds. Multiple sound tones received through a user terminal may be classified into objects, like images, and the individual objects may be merged with any reality that a user can feel. It is possible to objectize and informationize a plurality of sounds received through a user terminal to classify the sounds into objects, like images, so that the objectized sounds can be merged with any type of real environment that a user can feel.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. An acoustic object information merging apparatus, comprising:
an acoustic objectization unit to estimate a direction and a location of a received sound, to classify a sound pattern for the received sound based on the estimated direction and location of the received sound, and to identify an object for the received sound based on the sound pattern of the received sound;
an acoustic object information creator to acquire additional information about the identified object for the received sound, and to create acoustic object information therefrom; and
a merging unit to merge the acoustic object information with a real image or real sound.

2. The apparatus of claim 1, wherein the received sound is received by a microphone array.

3. The apparatus of claim 1, wherein the acoustic objectization unit identifies the object for the sound pattern of the sound.

4. The apparatus of claim 1, wherein the sound pattern of the received sound is a sound peak value.

5. The apparatus of claim 1, further comprising a sound pattern database to store a plurality of sound patterns for a plurality of acoustic objects.

6. The apparatus of claim 5, wherein the acoustic objectization unit further comprises:
a beamforming applying unit to classify the received sound into at least one sound tone; and
an acoustic object deciding unit to acquire the sound peak value of the sound tone classified by the beamforming applying unit and an object corresponding to the sound peak value from the sound pattern database.

7. The apparatus of claim 5, wherein the acoustic objectization unit further comprises a filtering applying unit to classify the received sound into at least one sound tone based on a frequency and an amplitude of the received sound; and wherein the acoustic object deciding unit acquires a sound peak value of the sound tone classified by the filtering applying unit, and acquires an object corresponding to the sound peak value from the sound pattern database.

8. The apparatus of claim 1, wherein the merging unit further comprises an image information merging unit to merge a real image with acoustic object information associated with the real image.

9. The apparatus of claim 8, wherein the real image is an image captured by a camera of a user terminal connected to the acoustic object information merging apparatus.

10. The apparatus of claim 9, wherein the merged image is outputted to a display of the user terminal.

11. The apparatus of claim 8, wherein the acoustic object information is in the form of a character, an icon, a picture or a moving picture.

12. The apparatus of claim 8, wherein the merging unit further comprises:
an acoustic information merging unit to merge a real sound or a real image with acoustic object information.

13. The apparatus of claim 12, wherein the real sound is received through a microphone of a user terminal connected to the acoustic object information merging apparatus.

14. The apparatus of claim 12, wherein the real image is an image captured by a camera of a user terminal connected to the acoustic object information merging apparatus.

15. The apparatus of claim 14, wherein the merged image is outputted to a display on the user terminal.

16. The apparatus of claim 12, wherein the acoustic object information is in the form of a character, an icon, a picture or a moving picture.

17. The apparatus of claim 8, wherein the merging unit further comprises a sound canceller to cancel sounds not corresponding to an object selected from among the objects in the merged image outputted to the user terminal.

18. The apparatus of claim 12, wherein the merging unit further comprises a sound canceller to cancel sounds not corresponding to an object selected from among the objects in the merged image outputted to the user terminal.

19. The apparatus of claim 18, wherein the apparatus further comprises a speaker to output a remaining sound corresponding to an object selected from among the objects in the merged image outputted to the user terminal.

20. A method of creating acoustic object information associated with sounds and merging the acoustic object information with real images or sounds in a user terminal, the method comprising:
estimating a direction and a location of a sound received through a microphone array;
classifying a sound pattern of the received sound based on the estimated direction and location of the received sound;
identifying an object associated with a sound peak value of the sound pattern by referencing to a sound pattern database that stores sound peak values of a plurality of objects;
acquiring additional information about the determined object to create acoustic object information for the received sound; and
merging the acoustic object information with a real image or sound.

21. The method of claim 20, wherein the method further comprises:
determining whether an object associated with the received sound is acquired;
classifying a second sound pattern for the received sound using a frequency and an amplitude of the received sound; and
identifying an object associated with the classified second sound pattern using a sound peak value of the classified second sound pattern by referencing a sound pattern database that stores sound peak values for a plurality of objects.

22. The method of claim 20, wherein the merging of the acoustic object information with the real image or sound comprises:
determining whether the acoustic object information is to be merged with a real image;
merging a real image captured by a camera of a user terminal with the acoustic object information; and
outputting the real image and the acoustic object information to the display of the user terminal.

23. The method of claim 21, wherein the merging of the acoustic object information with the real image or sound further comprises:
determining whether the acoustic object information is to be merged with a real sound;
merging a real sound received through a microphone of the user terminal with the acoustic object information; and
outputting the real sound and the acoustic object information to the display of the user terminal.
